(19) United States
(12) Patent Application Publication
(10) Pub. No.: US 2013/0011066 A1
(43) Pub. Date: Jan. 10, 2013

(54) System, Method, and Product for Handwriting Capture and Storage

(76) Inventor: Edward Balassanian, Kirkland, WA (US)

(21) Appl. No.: 13/540,814

(22) Filed: Jul. 3, 2012

Related U.S. Application Data
(60) Provisional application No. 61/505,201, filed on Jul. 7, 2011.

(51) Int. Cl. G06K 9/78; G06K 9/20; G06K 9/82; G06K 9/72

(52) U.S. Cl. 382/189

(57) ABSTRACT

In accordance with the present disclosure, there is provided a system, method, and product for capturing handwritten input as a page, storing the page in an electronic format, viewing pages on the device, uploading one or more pages to a web service, processing a page and storing pages for future access. Further, the system enables an individual to create topics and associate pages with a given category.

### CROSS-REFERENCE TO RELATED APPLICATIONS

This application claims the benefit of Provisional Patent Application Ser. No. 61/505,201, filed Jul. 7, 2011, for all purposes including but not limited to the right of priority and benefit of earlier filing date, and expressly incorporates by reference the entire content of Provisional Patent Application Ser. No. 61/505,201.

### BACKGROUND

Currently there are several different solutions for electronic handwriting capture in the market. Solutions include tablet computers, digital note pads and electronic pens. These solutions are not a viable alternative to regular pen and paper due to latency in pen stroke recognition and display, inconsistent handwriting recognition, power requirements, and limited tactile feel.

Tablet computers, such as the iPad™, have a variety of applications that allow users to capture handwritten notes. The user can use a finger or third party stylus pen to write directly on the touch sensitive display. One of the main drawbacks of tablet computers is that the mechanism for displaying the drawing is separate from the mechanism for capturing it. The iPad™ uses capacitive touch to determine where the users finger is and then it displays a pixel in the appropriate position. This results in lag, which detracts from the pen on paper feel. Additionally, tablet computers require frequent charging. Therefore, tablet computers do not provide an effective note taking experience.

Digital notepads are devices to allow an individual to write on ordinary paper on top of an electronic notepad with a specialized or proprietary pen. The pen communicates through the paper to a digital notepad configured to store handwriting strokes. To retrieve the notes a user connects the notepad to a computer to download, edit and manage their notes. Digital notepads suffer from poor handwriting recognition. Additionally, digital notepads require frequent battery charging or replacement. Therefore, digital notepads do not provide an effective note taking experience.

Electronic Pens are another option currently available in the market. Electronic pens capture and store handwriting movement as an individual writes. The handwritten notes are downloaded on a personal computer by connecting the pen via USB. Electronic pens are much larger than regular pens and require the individual to adjust how they write to ensure proper recognition. Additionally, these solutions often require a specific type of paper to the electronic pen to work properly. Therefore, electronic pens do not provide an effective note taking experience.

The prior art provides solutions for an individual to capture notes electronically, but current solutions lack tactile feel, have proprietary writing utensils that require users to change their natural writing style, require a rechargeable battery and a frequent power source, and often need a personal computer to retrieve electronic notes from the device.

A solution that provides an individual with a low powered responsive input device to capture handwriting combined with a display, has eluded those skilled in the art, until now.

A solution that provides an individual with instant capture, storage, and management of handwritten input from a device without requiring action has eluded those skilled in the art, until now.

It would be advantageous to provide a device that contains both a real-time input interface to capture handwriting and real-time display interface.

It would be advantageous to provide a device that is low powered and lightweight by only capturing input and not performing any handwriting recognition or other processing on the device.

It would be advantageous to provide a device wherein the mechanism to capture is separate from the input and display components.

It would be advantageous to provide a device that has a similar tactile feel to that of pen and paper.

It would also be advantageous to provide a device that automatically transmits captured input to a web service for processing, storage and management.

### BRIEF DESCRIPTION OF THE DRAWINGS

FIG. 1 is an illustration of one embodiment of an input device.

FIG. 2 is an illustration of representative embodiments of components of the present disclosed system, method, and product.

FIG. 3 is an illustration of one embodiment of the present disclosed system, method, and product.

FIG. 4 is a flow chart describing one embodiment of a page upload process.

FIG. 5 is a flow chart describing one embodiment of a page processing process.

FIG. 6 is an illustration of another embodiment of an input device.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Any combination of data storage devices, including without limitation computer servers, using any combination of programming languages and operating systems that support network connections, is contemplated for use in the present inventive method and system. The inventive method and system are also contemplated for use with any communication network, and with any method or technology which may be used to communicate with said network.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in communication networks of any type. Unless explicitly stated, the method embodiments described herein are not constrained to a particular order or sequence. Additionally, some of the described method embodiments or elements thereof can occur or be performed at the same point in time.

The present inventive system, method, and product relates to a electronic handwriting capture device that receives handwritten input though a stylus, displays the input, saves the input and uploads the input to a web service for processing.

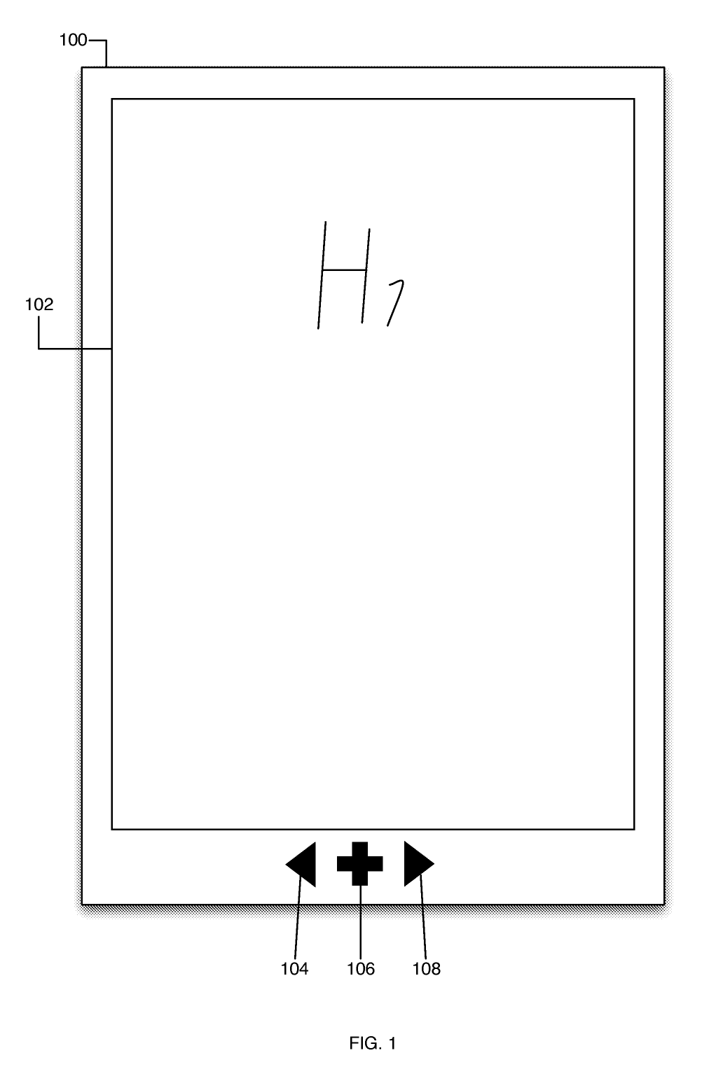

FIG. 1 is an illustration of one embodiment of an input device that receives handwritten user input through a stylus, displays the user input, saves the user input and uploads the user input to a web service for processing, in accordance with the present inventive system, method, and product. The input device 100 can be configured in any size, for example, 3×6, 6×9, 8.5×11, legal size or larger. In one embodiment, the input device input and display area 102 may be a combination of an e-ink display with pressure sensitive input screen. The input mechanism may be configurable to utilize low-power technologies such as cholesteric liquid crystal display or Quantum Tunneling Composite. The combination of e-ink display and input technology may be configurable to ensure the input device properly captures pen tracing in real-time while continuing to refresh the display in real-time with minimal power requirements. The input device may have a series of control buttons located on the device. There may be two directional buttons 104 and 108 that allow a user to navigate between pages previously created. The new page button 106 may clear the current user input on the screen and display a blank screen ready for new user input. Each time the screen is cleared the input device may save the previous user input as a page. Further, the device may scan the current page to determine which pixels were turned on or pressed. As used in this specification, a “page” is digital representation of user input, the digital representation being capable of being displayed in its entirety on the screen of the input device. In a further embodiment, the digital representation may comprise strokes and points data from the input device.

While for purposes of illustration the buttons are located at the bottom portion of the input device in FIG. 1, control buttons may be located anywhere on the device.

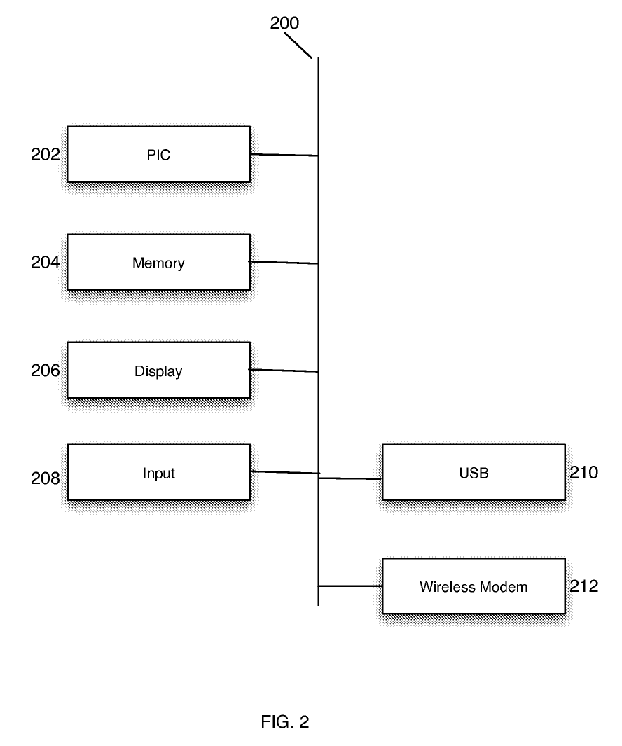

FIG. 2 is an illustration of the primary components within one embodiment of the input device. The system bus 200 connects the Peripheral Interface Controller (PIC) 202 with memory 204 configured to store pages, a display controller 206 for displaying pages, an input controller 208 for capturing the input, a scanner controller for scanning and saving a page, a USB controller 210 for power and connection to a personal computer to upload stored pages and a transmission component 212 for connecting and uploading stored pages to a web service. As illustrated in FIG. 2, the transmission component 212 is a wireless modem. However, any other device capable of transmitting data may be used. It is further contemplated that the transmission component 212 may receive data. In a preferred embodiment the memory 204 is non-volatile random access memory (NVRAM) or FLASH memory.

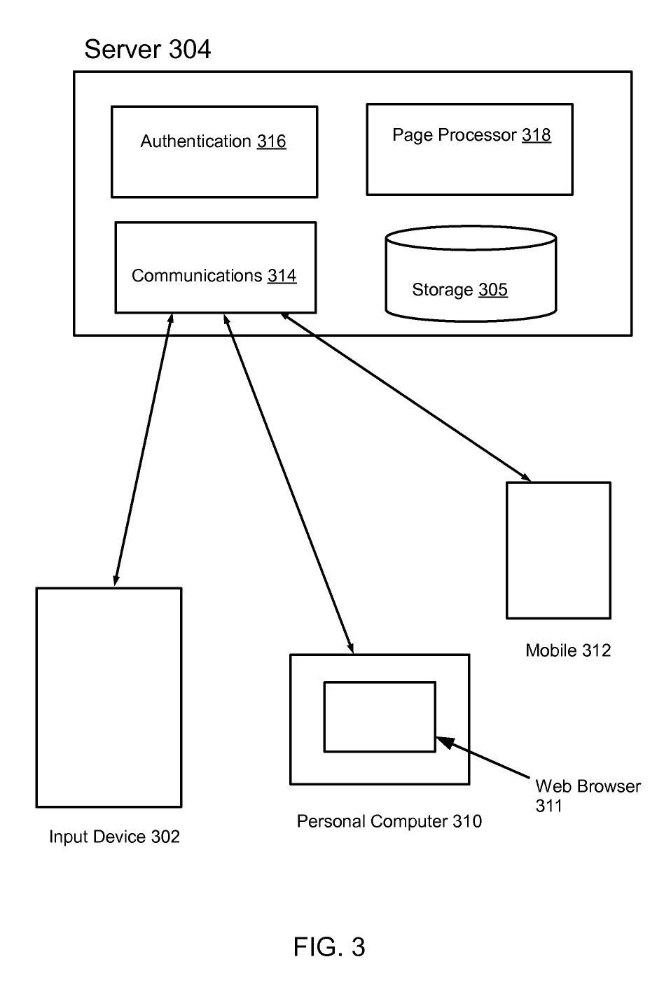

FIG. 3 is an illustration of one embodiment of the input device connected wirelessly to a web service operated at a computer server. Alternatively, the web service may be operated at a plurality of computer servers, and the components described herein (in connection with the computer server) may be distributed among the plurality of computer servers.

In a preferred embodiment the input device 302 uploads one or more pages via a wireless connection to the computer server. The wireless connection can be one of 802.11, GRPS, CDMA or any other wireless communication protocol. As illustrated in FIG. 3, there is a communications component 314 that receives the one or more pages from the input device 302 via a wireless connection. Communications component 314 may also transmit data to input device 302 or any other device associated with a user account with which the transmitted data is associated. FIG. 3 also illustrates authentication component 316 which may be configured to authenticate and associate one or more devices with a user account. For example and without limitation, authentication component 316 may associate input device 302, personal computer 310, and mobile device 312 with one particular user account.

FIG. 3 also illustrates page processor 318, which may be configured to process the one or more pages received from input device 302. The processing performed by page processor 318 may take a variety of different forms. Without limitation, the processing may include spell checking, determining a unique identifier based on a style of handwriting associated with the one or more pages, searching based on a keyword, or searching based on a unique handwriting style identifier.

The input device 302 may be associated with a specific user account. The input device may upload to a server 304. The newly uploaded pages may be stored in storage 305 and associated with a specific user. Processing may be performed on the uploaded pages. In the embodiment illustrated in FIG. 3, a user can access his or her stored pages via a personal computer 310 or a mobile device 312. By accessing his or her stored pages, each user may view those pages, manage those pages, annotate those pages, and categorize those pages.

It is contemplated that a user account may have multiple devices associated with it.

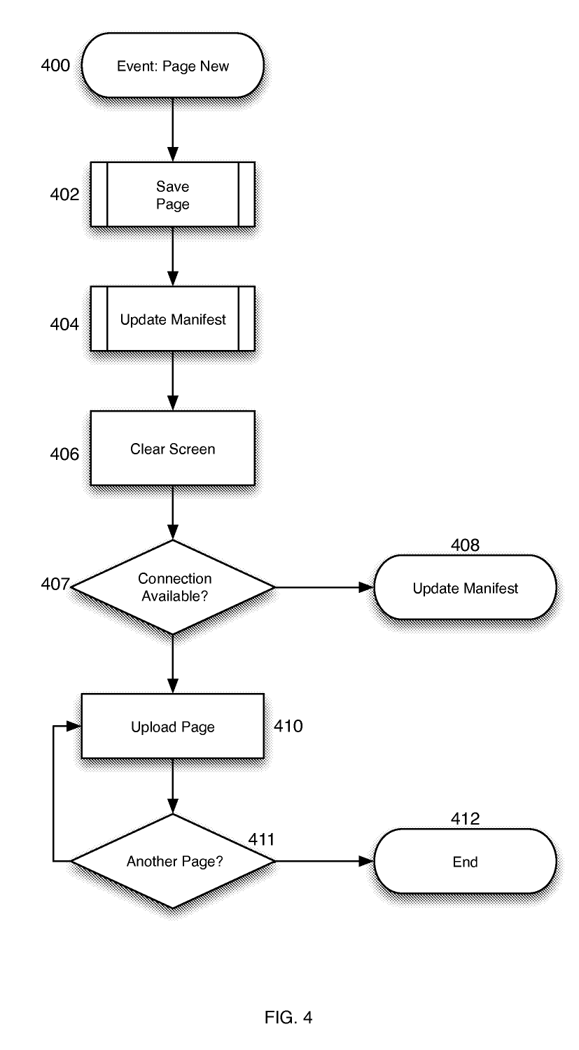

FIG. 4 is a flow chart illustrating one embodiment of the page upload process. In this embodiment, the process starts when the input device controller receives a command to create a new page 400. Next, the page is scanned and stored 402 to local memory. In the illustrated embodiment, the input device itself does not perform any handwriting recognition. Rather the page input is scanned to determine which pixels user writing activated. This enables the device to require no power to receive input, only power when the scan process is executed as part of the new page event. Next, the page manifest is updated 404. The page manifest is configured to track the current number of pages, record an associated time stamp for each saved page, and further record a page upload status value for each page to indicate whether that page has been uploaded. Once the page has been saved and the page manifest updated the screen is cleared 406. Next, the process determines if a connection is available 407. If a connection is not available the process updates the page manifest 408 noting the current page has not been uploaded and then ends. If a connection is available the page is uploaded 410. Next, the process checks the page manifest to see if there are additional pages 411 to upload. If there are additional pages for upload the process repeats until complete. The page manifest is updated and the process ends 412. In one embodiment, to maintain low power consumption, the input device can be configured to turn the wireless connection off when not in use. Further, the upload process can be on a set time interval.

In a further embodiment, the input device can be configured to enable a user to annotate or add to an existing page. The annotated page may be saved as a new page or saved as an update to the existing page.

Further, the pages may be versioned. Each time an existing page is annotated or added to, it may be versioned. For example, Page 1 would have a version value of pg1:v1 (page 1, version 1) when it is initially created. In one embodiment, when the user annotates page 1, and when it is saved as an update to that page, it would be versioned as pg1:v2 (page 1, version 2). Each version may be tagged and stored on the server. The user may revert back to one or more specific versions of the page.

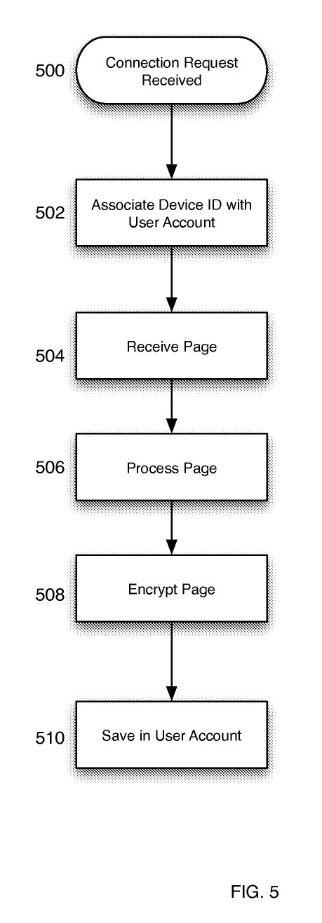

FIG. 5 is a flow chart illustrating one embodiment of a process whereby pages are received at a server. In the illustrated embodiment, the process starts when a connection request is received 500 by the web service from a Input device. The connection request contains a device ID from the requesting input device. The service authenticates the device ID with a specific user account 502. Once a connection is established and authenticated, the process receives one or more pages from the input device 504. Next, upon receipt the service processes 506 the page(s). In this embodiment, processing includes identifying the points and strokes vector data that correlates to the user's handwritten input. In further embodiments, this process can be configured to use one or more algorithms to determine handwritten user input, including without limitation vector analysis, line extraction, seam carving, lexicon reduction algorithms or any series of algorithms. Once the writing from a page has been identified, processing can include optical character recognition (OCR) to convert the handwritten text into machine-encoded text. After processing, the page can be optionally encrypted 508. The process may be configurable by a user to encrypt the page(s) with a passcode. Next the processed page(s) are stored in a user account and the process ends 510.

In a further embodiment, the device can be connected to a personal computer via USB. An application executing on the computer may retrieve the new pages from the input device, process the new pages, and allow the user to manage the new pages. Further the application may simply serve as a mechanism to upload to the web service if the input device does not have wireless.

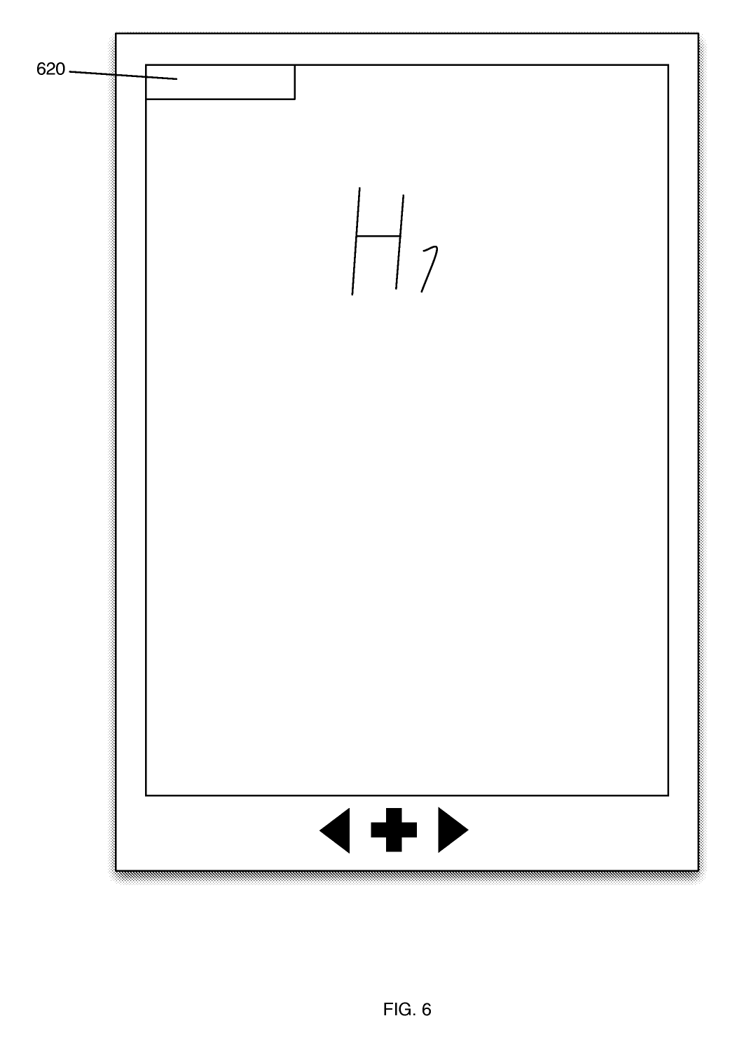

In a further embodiment, the input device may have multiple categories or topics. As illustrated in FIG. 6, the user can write in a category or topic in the reserved category field 620. When pages are uploaded to the web service for processing, the service may check the reserved category field. The service may then associate that page with the category or topic previously created by the user. Further, a user can associate previously created pages to categories or topics. In a further embodiment, the system may display permanent categories or topics created by a user in a tab like interface. Tab fields may be updated each time the input device syncs to the computer server or to local data storage.

In a further embodiment, the computer server may be configured to enable users to access the stored pages through a website or mobile device to read notes. In this embodiment, the user can only view the original pages and annotate them, but cannot change what has previously been written.

In a further embodiment, a user may access one or more stored pages through a website and further configure the processing component (i.e., page processor 318) to further determine one or more specific keywords or figures that result in the stored electronic page storing the one or more specific keywords or figures to display in one or more different colors. In this embodiment, the user can configure the server processing to recognize keywords or specific figures and convert those words to a specific color. For example, the user can instruct the page processor that if a page is uploaded—and after processing, it is determined that the word “Important” is on that page—then, before storing the page in its final form, the page processor will make the word “Important” display as red. Further, in this embodiment, the user can configure the system to recognize a box on a page and instruct the server to convert the color of all handwriting in the box to the color blue. Even further, any number of processing actions can be set by a user to be triggered based on a specific keyword or figure. For example, and without limitation, “share=email” may instruct the system to share the page by emailing a digital copy (e.g., PDF) to the email address the user provided. In another example, for each page on which the user draws a representation of a key, that page may be automatically encrypted during the processing.

In a further embodiment, processing may include the recognition of one or more styles of handwriting. The handwriting style can be determined over a period of time using any of, but not limited to the following data: line quality, spacing of words and letters, ratio of the relative height, width and size of letters, pen lifts and separations, connecting strokes, beginning and ending strokes, unusual or unique letter formation, shading or pen pressure, slant, baseline habits, flourishes and embellishments and diacritic placement. It is understood that all of these data, any subset of them, or none at all may be used to create a unique ID for given handwriting style. Further, any other handwriting recognition algorithm can be used as part of the process. A unique ID may be stored for each handwriting style.

In an even further embodiment, the handwriting style can be used for searching the stored documents. For example, the input device may have a specific button for search. When the user selects the search button a blank page may be displayed. The user may write a keyword to search for or search based on a writing style. In an example embodiment, the user may write “keyword=important” on the blank page. When the user selects a new page button or other button to trigger the search, the page may be uploaded to the server and processed, and the stored pages may be searched for the key word “important”. All pages that contain that the word “important” may be returned to the user to review on the input device. Further, the user may write “style” and submit it to the server for processing. Based on the style of handwriting the user used to write “style” the system may attempt to generate a style ID and return all pages that have that handwriting style ID to the user on the input device.

In a further embodiment, notes may be shared via the computer server at the web service or directly from the input device. As described above, the computer server can be configured to recognize keywords such as “share”, as well as email addresses to share with. Further, each user can configure the web service to integrate with his or her contacts such that the user only has to write the name of the person with whom they want the page or pages to be shared—for example, Bob Jones. Further, the user may share one or more pages directly from the website.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A system for capturing and processing handwritten input, the system comprising;
a) an input device, the input device comprising;
an input component configured to receive handwritten input;
a display component configured to display the handwritten input;
a first storage component configured to store the handwritten input as one or more pages; and
a transmission component configured to transmit the one or more pages; and
b) a computer server, the computer server comprising;
a communications component configured to receive the one or more pages from the transmission component;
an authentication component configured to authenticate and associate one or more devices with a user account;
a page processor component configured to process the one or more received pages; and
a second storage component configured to store the one or more processed pages associated with a specific user;

2. The system of claim 1 wherein the computer server is configured to allow a user to access stored pages via a web browser.

3. The system of claim 1 wherein the page processor is configured to perform one or more of the following: vector analysis, line extraction, seam carving or lexicon reduction to identify handwriting input within each page.

4. The system of claim 1 wherein the page processor is configured to perform optical character recognition.

5. The system of claim 1 wherein the page processor is configured to encrypt the one or more pages before storage.

6. The system of claim 1 wherein processing includes determining a unique identifier based on the style of handwriting.

7. The system of claim 1 wherein processing includes spell checking.

8. The system of claim 1 wherein processing includes searching based on a keyword.

9. The system of claim 1 wherein processing includes searching based on a unique handwriting style identifier.

10. The system of claim 1 wherein the page processing component is configured by a user.

11. An input device configured to capture handwritten input in electronic form and transmit it to a computer server, the device comprising;
an input component configured to receive handwritten input;
a display component configured to display the handwritten input;
a storage component configured to store the handwritten input; and
a transmission component configured to transmit the handwritten input to the computer server.

12. The input device of claim 11 wherein the transmission component is further configured to receive one or more pages from the computer server.

13. The input device of claim 12 wherein the input device is configured to display the one or more received pages.

14. The input device of claim 12 wherein the user can add handwritten input to the one or more received pages, but cannot erase pre-existing handwritten input.

15. The input device of claim 14 wherein the additional handwriting added to a previously captured page is stored as a new page.

16. The input device of claim 11 wherein the input component and display component are the same component.

17. The input device of claim 11 wherein the input component comprises low power cholesteric liquid crystals.

18. The input device of claim 11 wherein the input component comprises low power quantum tunneling composite.

19. The input device of claim 11 wherein the input component comprises low power electronic ink.

20. The input device of claim 11 wherein the display component comprises low power cholesteric liquid crystals.

21. The input device of claim 11 wherein the display component comprises low power electronic ink.

22. The input device of claim 11 further comprising a scanner controller, wherein the scanner controller is configured to scan the display component to determine which, if any, pixels were activated.

23. The input device of claim 22 wherein the scanner controller is further configured to store the captured information in the storage component.

24. The input device of claim 23 wherein the captured information is stored as one or more numerical values, the one or more numerical values representing one or more strokes and points from the handwritten input.
